(19) United States
(12) Patent Application Publication
(10) Pub. No.: US 2022/0372801 A1
(43) Pub. Date: Nov. 24, 2022

(54) Vehicle Door Handle Assembly and Related Methods

(71) Applicant: Huf Hülsbeck & Fürst GmbH & Co. KG, Velbert (DE)

(72) Inventors: Suat Kaya, Novi, MI (US); Gunghun Jang, New Hudson, MI (US); Sami Yanikoglu, Ann Arbor, MI (US); Ayushi Srivastava, Farmington Hills, MI (US)

(73) Assignee: Huf Hülsbeck & Fürst GmbH & Co. KG, Velbert (DE)

(21) Appl. No.: 17/327,731

(22) Filed: May 23, 2021

(51) Int. Cl. E05B 85/16

(52) U.S. Cl. CPC E05B 85/16

(57) ABSTRACT

A handle assembly includes a body and an electrical subassembly. The body extends from a proximal end to a distal end and defines a cavity extending between the proximal end and the distal end. The body further defines an opening at the distal end and includes a first projection disposed proximate the distal end. The electrical subassembly is disposed within the cavity and configured to extend through the opening. The electrical subassembly includes a second projection pivotally coupled to the first projection.

### FIELD

The present disclosure relates generally to a vehicle door handle, and more particularly to an assembly and related methods for a vehicle door handle.

### BACKGROUND

This section provides background information related to the present disclosure and is not necessarily prior art.

Doors on vehicles such as cars and trucks are provided with handle assemblies to allow a user to easily open and close the doors. Such handle assemblies often include various components that are assembled relative to one another and relative to the door when the vehicle is manufactured. Often, the assembly of such components requires precise alignment and movement between the various components to ensure a secure and robust connection therebetween. While known handle assemblies have proven acceptable for their intended purpose, a there remains a continuous need for improvement in the pertinent art.

### SUMMARY

This section provides a general summary of the disclosure, and is not a comprehensive disclosure of its full scope or all of its features.

One aspect of the disclosure provides a handle assembly. The handle assembly includes a body and an electrical subassembly. The body extends from a proximal end to a distal end and defines a cavity extending between the proximal end and the distal end. The body further defines an opening at the distal end and includes a first projection disposed proximate the distal end. The electrical subassembly is disposed within the cavity and configured to extend through the opening. The electrical subassembly includes a second projection pivotally coupled to the first projection.

Implementations of this aspect of the disclosure may include one or more of the following optional features. In some implementations, the electrical subassembly includes a third projection configured to secure the electrical subassembly to the body. The second projection may be disposed at a proximal end of the electrical subassembly. The third projection may be disposed at a distal end of the electrical subassembly. The third projection may be disposed within an aperture defined by the body. The third projection may include a lip engaging the body. The electrical subassembly may include a proximal leg and a distal leg forming an L-shape. The proximal leg may extend from the proximal end to the distal leg. The distal leg may extend from the proximal leg to the distal end.

In some implementations, the body defines a channel extending between the cavity and the proximal end. The electrical subassembly may include a wire disposed within the channel. The body may include a projection securing the wire within the channel.

In some implementations, the electrical subassembly includes a connector extending from the proximal end of the body. The body may include a clip defining an aperture. The connector may include a projection disposed within the aperture.

Yet another aspect of the present disclosure provides a method of assembling a handle assembly. The method includes providing a body extending from a proximal end to a distal end. The body defines a cavity extending between the proximal end and the distal end. The body also defines an opening at the distal end. The body includes a first projection disposed proximate the distal end. The method includes moving an electrical subassembly into the opening. The method also includes pivoting the electrical subassembly relative to the body. The method further includes disposing the electrical subassembly within the cavity.

Implementations of this aspect of the disclosure may include one or more of the following optional features. In some implementations, the electrical subassembly includes a second projection, and the method further includes coupling the first projection to the second projection. Pivoting the electrical subassembly relative to the body may include pivoting one of the first projection or the second projection within the other of the first projection or the second projection. The electrical subassembly may include a third projection, and the method may further includes securing the third projection to the body. The second projection may be disposed at a proximal end of the electrical subassembly. The third projection may be disposed at a distal end of the electrical subassembly. The method may further include disposing the third projection within an aperture defined by the body.

In some implementations, the method includes engaging a lip of the third projection with the body.

In some implementations, the body defines a channel extending between the cavity and the proximal end, and the electrical subassembly includes a wire. The method may further include disposing the wire within the channel. The body may include a projection, and the method may further include engaging the projection with the wire to secure the wire within the channel.

In some implementations, the electrical subassembly includes a connector extending from the proximal end of the body. The body may include a clip defining an aperture. The method may further include disposing a projection of the connector within the aperture.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1 is a perspective view of a vehicle having a handle assembly in accordance with the principles of the present disclosure.

FIG. 2 is a rear perspective view of the handle assembly of FIG. 1.

FIG. 3 is an exploded view of the handle assembly of FIG. 1.

FIG. 4A is a cross-sectional view of a portion of the handle assembly of FIG. 1 during a method of assembly in accordance with the principles of the present disclosure.

FIG. 4B is another cross-sectional view of a portion of the handle assembly of FIG. 1 during the method of assembly in accordance with the principles of the present disclosure.

FIG. 4C is a front view of the handle assembly of FIG. 1 during the method of assembly in accordance with the principles of the present disclosure.

FIG. 5 is a perspective view of a portion of a body and an electrical subassembly of the handle assembly of FIG. 1 in accordance with the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

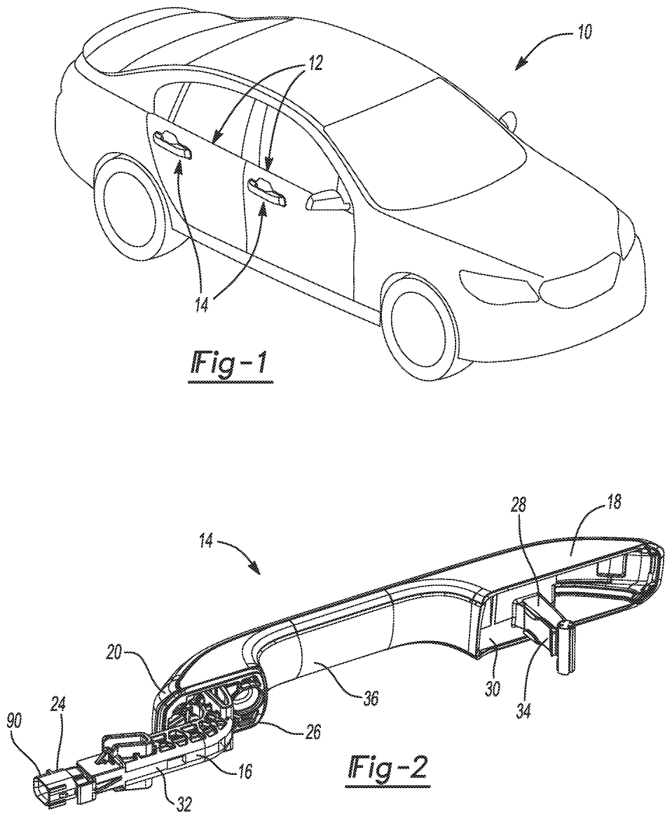

With reference to FIG. 1, a vehicle 10 including one or more doors 12 is illustrated. While the vehicle 10 is generally shown and described herein as being a car, it will be appreciated that the vehicle 10 may include other forms (e.g., a truck, a bus, a recreational vehicle, etc.) within the scope of the present disclosure. Each door 12 may include a handle assembly 14 coupled thereto to allow a user to open the door 12 and access an interior space of the vehicle 10.

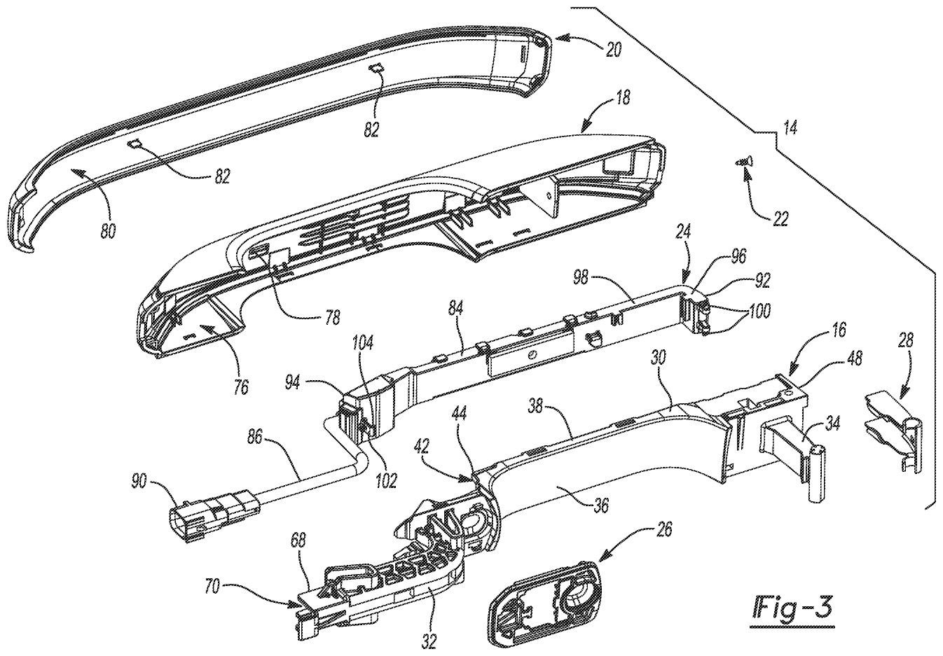

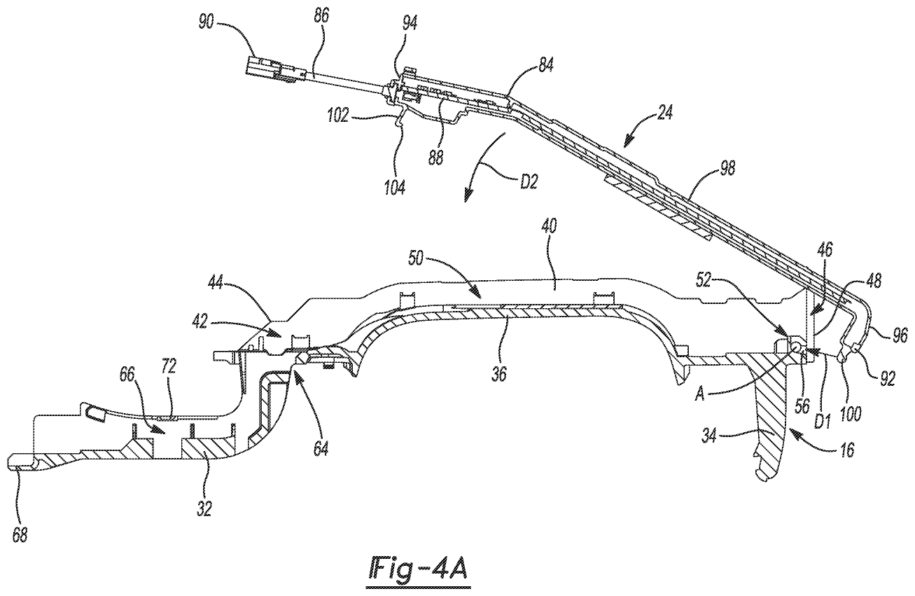

Referring to FIGS. 2 and 3, the handle assembly 14 may include a body 16, a cover 18, a trim strip 20, a fastener 22, an electrical subassembly 24, a grip pad 26, and a shoe 28. In an assembled configuration (e.g., FIG. 1), the handle assembly 14 may be pivotally coupled to the door 12. In particular a portion of the body 16 may be pivotally coupled to the door 12 such that, upon application of a force upon the handle assembly 14 by a user, the handle assembly 14 pivots and/or translates relative to the door 12, thus allowing user to open the door 12 and enter or exit the vehicle.

With reference to FIGS. 2-4C, the body 16 may include a housing portion 30, a proximal leg 32, and a distal leg 34. The housing portion 30 may include a base wall 36, a first sidewall 38, and a second sidewall 40. The base wall 36, the first sidewall 38, and the second sidewall 40 may define a proximal opening 42 at a proximal end 44 of the housing portion 30, a distal opening 46 at a distal end 48 of the housing portion 30, and a cavity 50 extending from the proximal opening 42 to the distal opening 48, thus allowing for fluid communication between the proximal and distal openings 42, 48 through the cavity 50.

The first sidewall 38 may include a first retaining member 52. In some implementations, the retaining member 52 includes a boss projecting from one or more of the base wall 36 and/or first sidewall 38 and defining an opening 56 facing the distal end 48 of the housing portion 30. The second sidewall 40 may include a second retaining member 58. In some implementations, the second retaining member 58 includes a boss projecting from one or more of the base wall 36 and/or second sidewall 40 and defining an opening 60 facing the distal end 48 of the housing portion 30. The retaining members 52, 58 may be disposed proximate to (e.g., a distance that is less than 25% of the distance between the proximal and distal ends 44, 48) the distal end 48. In some implementations, the housing portion 30 (e.g., the base wall 36) defines an aperture 64 extending through the housing portion 30.

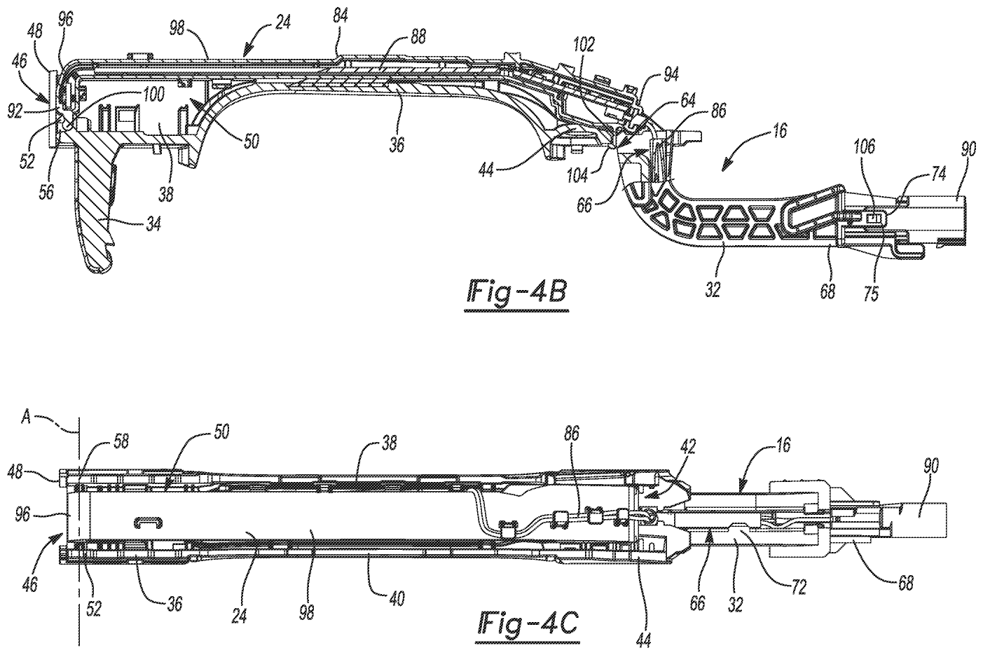

The proximal leg 32 may extend from the proximal end 44 of the housing portion 30. As illustrated in FIG. 4A, in some implementations, the proximal leg 32 defines a channel 66 extending from the proximal end 44 of the housing portion 30 to a distal end 68 of the proximal leg 32. The distal end 68 may define an opening 70 in fluid communication with the channel 66. In some configurations, the proximal leg 32 includes one or more projections 72 extending into the channel 66, and one or more retaining elements (e.g., clips 74) extending from the distal end 68. In some implementations, the clip 74 defines an aperture 75 extending therethrough. As will be explained in more detail below, in an assembled configuration, the electrical subassembly 24 may be disposed within the cavity 50 and the channel 66 and secured to the body 16 via one or more of the retaining members 52, 58, the projection(s) 72, and/or the clip 74.

Referring to FIG. 3, the cover 18 may form a cavity 76 and may define one or more apertures 78 extending through the cover 18 and into the cavity 76. The trim strip 20 may define a cavity 80 and include one or more projections 82 extending into the cavity. As will be explained in more detail below, in an assembled configuration, at least a portion of the body 16 may be disposed within the cavity 76 and coupled to the cover 18, and at least a portion of the cover 18 may be disposed within the cavity 80 and coupled to the trim strip 20. In particular, each projection 82 may be disposed within one of the 78 to align the cover 18 with the trim strip 20 and/or help secure it thereto.

As illustrated in FIG. 3, The electrical subassembly 24 may include a housing 84, one or more electrical and/or circuitry elements (e.g., wires 86, circuit board 88, light-emitting diodes, sensors, etc.), and a connector 90. The connector 90 may be in electrical communication with the various electrical elements through the wires 86 to transmit power from the vehicle to the handle assembly 14. In some implementations, the housing 84 defines a “L”-shaped construct extending from a proximal end 92 to a distal end 94. In this regard, the housing 84 may include a proximal leg 96 extending in a first direction from the proximal end 92, and a distal leg 98 extending from the proximal leg 96 to the distal end 94 in a second direction transverse (e.g., perpendicular) to the first direction. As will be explained in more detail below, the substantially “L”-shaped construct of the housing 84 may assist a user with assembling the electrical subassembly 24 relative to the body 16.

In some implementations, the proximal end 92 includes one or more retaining members (e.g., projections 100) extending therefrom, and the distal end 94 includes one or more retaining members (e.g., projections 102) extending therefrom. In some implementations, the projections 100 are disposed proximate to (e.g., a distance that is less than 25% of the distance between the proximal and distal ends 92, 94) the proximal end 92. The projections 100 may include and/or define a pair of axially-extending axles 101 about which the electrical subassembly 24 pivots during a method of assembling the handle assembly 12, while the projection 102 may include a lip 104 projecting therefrom and operable to secure the electrical subassembly 24 to the body 16 during the method of assembly, as will be described in more detail below.

A method of assembling the handle assembly 14 will now be described with reference to FIGS. 4A-4C. In this regard, the method may include coupling the proximal end 92 of the electrical subassembly 24 to the body 16. For example, the method may include coupling the retaining members (e.g., projections 100) to the retaining members 52, 58. In particular, the method may include moving the electrical subassembly 24 in a first direction D1 through the opening 46 and disposing the retaining members (e.g., projections 100) into the openings 56, 60 of the retaining members 52, 58.

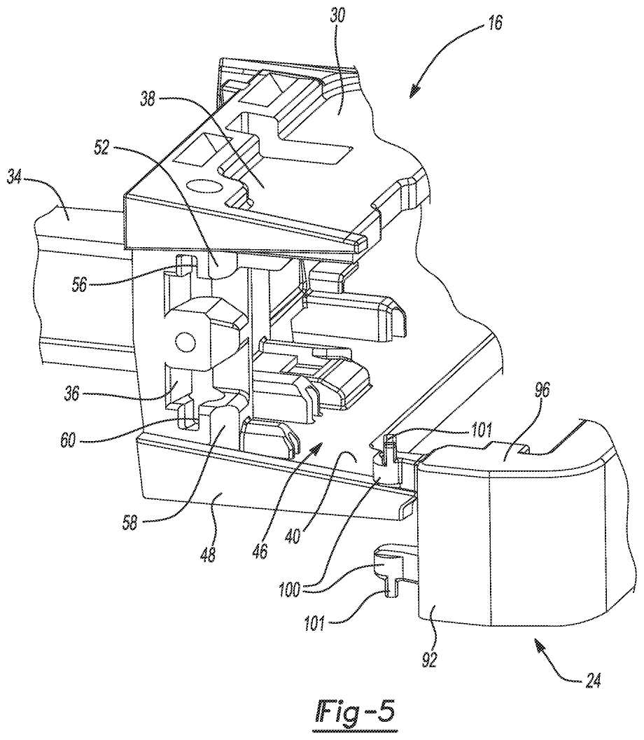

The method of assembling the handle assembly 14 may also include disposing the electrical subassembly 24 within the cavity 50 of the body 16. For example, the method may include moving the electrical subassembly 24 in a direction D2 until the electrical subassembly 24 is located within the cavity 50. In particular, the method may include rotating the electrical subassembly 24 about an axis A extending through the projections 100 until the electrical subassembly 24 is located within the cavity 50. As illustrated in FIG. 5, in some implementations, the axles 101 define a rectangular cross-sectional shape that is received by the openings 56, 60 defining corresponding rectangular cross-sectional shapes. Upon rotating, the electrical subassembly 24 about the axis, the axles 101 may become secured within the retaining members 52, 58 due to a cross-sectional dimension of the axle 101 being greater than a cross-sectional dimension of the openings 56, 60.

The method of assembling the handle assembly 14 may further include coupling the distal end 94 of the electrical subassembly 24 to the body. For example, the method may include inserting the retaining member 102 through the aperture 64 and engaging the lip 104 with a portion of the body 16 to secure the electrical subassembly 24 to the body 16 within the cavity 50.

The method of assembling the handle assembly 14 may also include coupling the wires 86 to the body 16. For example, the method may include disposing the wires 86 within the channel 66 such that the wires 86 and/or the connector 90 extend from the distal end 68 of the proximal leg 32. In particular, the method may include disposing the wires 86 within the channel 66 such that the projection 72 engages the wires 86 and/or the wires 86 are disposed between the projection 72 and a bottom portion of the proximal leg 32.

The method of assembling the handle assembly 14 may further include coupling the connector 90 to the body 16. For example, the method may include positioning at least a portion of the connector 90 within the channel 66 such that the retaining element 74 secures the connector 90 to the body 16. In particular, the method may include securing a portion (e.g., a projection 106) of the connector 90 within the aperture 75 of the body 16.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

As noted above, each of the embodiments described in the detailed description above may include any of the features, options, and possibilities set out in the present disclosure figures, including those under the other independent embodiments, and may also include any combination of any of the features, options, and possibilities set out in the present disclosure and figures. Further examples consistent with the present teachings described herein are set out in the following numbered clauses:.

Clause 1: A handle assembly comprising: a body extending from a proximal end to a distal end, the body defining a cavity extending between the proximal end and the distal end, and an opening at the distal end, the body including a first projection disposed proximate the distal end; and an electrical subassembly disposed within the cavity and configured to extend through the opening, the electrical subassembly including a second projection pivotally coupled to the first projection.

Clause 2: The handle assembly of clause 1, wherein the electrical subassembly includes a third projection configured to secure the electrical subassembly to the body.

Clause 3: The handle assembly of clause 2, wherein the second projection is disposed at a proximal end of the electrical subassembly, and the third projection is disposed at a distal end of the electrical subassembly.

Clause 4: The handle assembly of clause 3, wherein the third projection is disposed within an aperture defined by the body.

Clause 5: The handle assembly of clause 4, wherein the third projection includes a lip engaging the body.

Clause 6: The handle assembly of any of clauses 3 through 5, wherein the electrical subassembly includes a proximal leg and a distal leg forming an L-shape, the proximal leg extending from the proximal end to the distal leg, the distal leg extending from the proximal leg to the distal end.

Clause 7: The handle assembly of any of clauses 1 through 6, wherein the body defines a channel extending between the cavity and the proximal end, and wherein the electrical subassembly includes a wire disposed within the channel.

Clause 8: The handle assembly of clause 7, wherein the body includes a projection securing the wire within the channel.

Clause 9: The handle assembly of any of clauses 1 through 8, wherein the electrical subassembly includes a connector extending from the proximal end of the body.

Clause 10: The handle assembly of clause 9, wherein the body includes a clip defining an aperture, and wherein the connector includes a projection disposed within the aperture.

Clause 11: A method of assembling a handle assembly, the method comprising: providing a body extending from a proximal end to a distal end, the body defining a cavity extending between the proximal end and the distal end, and an opening at the distal end, the body including a first projection disposed proximate the distal end; moving an electrical subassembly into the opening; pivoting the electrical subassembly relative to the body; and disposing the electrical subassembly within the cavity.

Clause 12: The method of clause 11, wherein the electrical subassembly includes a second projection, the method further comprising coupling the first projection to the second projection.

Clause 13: The method of clause 12, wherein pivoting the electrical subassembly relative to the body includes pivoting one of the first projection or the second projection within the other of the first projection or the second projection.

Clause 14: The method of clause 13, wherein the electrical subassembly includes a third projection, the method further comprising securing the third projection to the body.

Clause 15: The method of clause 14, wherein the second projection is disposed at a proximal end of the electrical subassembly, and the third projection is disposed at a distal end of the electrical subassembly, the method further comprising disposing the third projection within an aperture defined by the body.

Clause 16: The method of clause 15, further comprising engaging a lip of the third projection with the body.

Clause 17: The method of any of clauses 11 through 16, wherein the body defines a channel extending between the cavity and the proximal end, and wherein the electrical subassembly includes a wire, the method further comprising disposing the wire within the channel.

Clause 18: The method of clause 17, wherein the body includes a projection, the method further comprising engaging the projection with the wire to secure the wire within the channel.

Clause 19: The method of any of clauses 11 through 18, wherein the electrical subassembly includes a connector extending from the proximal end of the body, and wherein the body includes a clip defining an aperture, the method further comprising disposing a projection of the connector within the aperture.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A handle assembly comprising:
a body extending from a proximal end to a distal end, the body defining a cavity extending between the proximal end and the distal end, and an opening at the distal end, the body including a first projection disposed proximate the distal end; and
an electrical subassembly disposed within the cavity and configured to extend through the opening, the electrical subassembly including a second projection pivotally coupled to the first projection.

2. The handle assembly of claim 1, wherein the electrical subassembly includes a third projection configured to secure the electrical subassembly to the body.

3. The handle assembly of claim 2, wherein the second projection is disposed at a proximal end of the electrical subassembly, and the third projection is disposed at a distal end of the electrical subassembly.

4. The handle assembly of claim 3, wherein the third projection is disposed within an aperture defined by the body.

5. The handle assembly of claim 4, wherein the third projection includes a lip engaging the body.

6. The handle assembly of claim 3, wherein the electrical subassembly includes a proximal leg and a distal leg forming an L-shape, the proximal leg extending from the proximal end to the distal leg, the distal leg extending from the proximal leg to the distal end.

7. The handle assembly of claim 1, wherein the body defines a channel extending between the cavity and the proximal end, and wherein the electrical subassembly includes a wire disposed within the channel.

8. The handle assembly of claim 7, wherein the body includes a projection securing the wire within the channel.

9. The handle assembly of claim 1, wherein the electrical subassembly includes a connector extending from the proximal end of the body.

10. The handle assembly of claim 9, wherein the body includes a clip defining an aperture, and wherein the connector includes a projection disposed within the aperture.

11. A method of assembling a handle assembly, the method comprising:
providing a body extending from a proximal end to a distal end, the body defining a cavity extending between the proximal end and the distal end, and an opening at the distal end, the body including a first projection disposed proximate the distal end;
moving an electrical subassembly into the opening;
pivoting the electrical subassembly relative to the body; and
disposing the electrical subassembly within the cavity.

12. The method of claim 11, wherein the electrical subassembly includes a second projection, the method further comprising coupling the first projection to the second projection.

13. The method of claim 12, wherein pivoting the electrical subassembly relative to the body includes pivoting one of the first projection or the second projection within the other of the first projection or the second projection.

14. The method of claim 13, wherein the electrical subassembly includes a third projection, the method further comprising securing the third projection to the body.

15. The method of claim 14, wherein the second projection is disposed at a proximal end of the electrical subassembly, and the third projection is disposed at a distal end of the electrical subassembly, the method further comprising disposing the third projection within an aperture defined by the body.

16. The method of claim 15, further comprising engaging a lip of the third projection with the body.

17. The method of claim 11, wherein the body defines a channel extending between the cavity and the proximal end, and wherein the electrical subassembly includes a wire, the method further comprising disposing the wire within the channel.

18. The method of claim 17, wherein the body includes a projection, the method further comprising engaging the projection with the wire to secure the wire within the channel.

19. The method of claim 11, wherein the electrical subassembly includes a connector extending from the proximal end of the body, and wherein the body includes a clip defining an aperture, the method further comprising disposing a projection of the connector within the aperture.
